(19) United States
(12) Patent Application Publication
(10) Pub. No.: US 2024/0369519 A1
(43) Pub. Date: Nov. 7, 2024

(54) AI-Accelerated Analysis Method, Evaluation Unit, Gas Chromatograph, Analysis System and Computer Program Product

(71) Applicant: Siemens Aktiengesellschaft, Muenchen (DE)

(72) Inventors: Piotr STRAUCH, Rülzheim (DE); Andreas HANGAUER, München (DE)

(21) Appl. No.: 18/685,964

(22) PCT Filed: Jul. 6, 2022
(86) PCT No.: PCT/EP2022/068710

§ 371 Date: Feb. 23, 2024

(30) Foreign Application Priority Data
Aug. 26, 2021 (EP) 21193262.9

(51) Int. Cl. G01N 30/86; G01N 30/02; G01N 30/74

(52) U.S. Cl. CPC G01N 30/8696; G01N 30/74; G01N 30/8679; G01N 30/8693; G01N 2030/025

(57) ABSTRACT

An evaluation unit, a gas chromatograph, an analysis system, a computer program product and method for determining the composition of a sample containing at least three components via the gas chromatograph, wherein a concentration of a first component of the sample is quantitatively determined and the concentration is output as a first partial measured value to an artificial intelligence, a concentration of the second and third components of the sample is determined via the artificial intelligence and the determined concentrations are output, a concentration of the second component of the sample is quantitatively determined and the concentration is output as a second partial measured value to the artificial intelligence, the concentration of the third component of the sample is determined via the artificial intelligence and the determined concentration is output, where method is performed within a first measurement cycle of the gas chromatograph in which the sample is examined.

### CROSS-REFERENCE TO RELATED APPLICATIONS

This is a U.S. national stage of application No. PCT/EP2022/068710 filed 6 Jul. 2022. Priority is claimed on European Application No. 21193262.9 filed 26 Aug. 2021, the content of which is incorporated herein by reference in its entirety.

### BACKGROUND OF THE INVENTION

### 1. Field of the Invention

The invention relates to an analysis method for ascertaining a composition of a substance sample, which is accelerated by an artificial intelligence, relates to an evaluation unit for performing the method, relates to a gas chromatograph including the evaluation unit, relates to an analysis system that is based on a correspondingly trained artificial intelligence, and furthermore relates to a computer program product that is forms a corresponding artificial intelligence.

### 2. Description of the Related Art

CN 111443160 A discloses an apparatus that can be used to monitor fermentation processes or waste gas compositions. The apparatus includes a gas sensor array and a gas chromatograph. Measured values from the gas sensor array are linked to measured values of the gas chromatograph via data analysis. This occurs using a machine learning algorithm.

Gas chromatography methods are used in various manufacturing processes in the chemical industry in the monitoring of waste gases or the purity of a product to determine the composition of a substance sample. For numerous processes, gas chromatography measurements are too slow to monitor the composition of the corresponding substance samples with sufficient accuracy.

### SUMMARY OF THE INVENTION

It is an object of the invention to provide the possibility to ascertain a composition of a substance sample in an accelerated manner with high measuring accuracy. This and other objects and advantages are achieved in accordance with the invention by a method for ascertaining the composition of a substance sample. The substance sample comprises a mixture of at least three components, where the respective concentrations are to be determined. The method is performed via a gas chromatograph in which the substance sample is fractionated by a separating apparatus into the at least three components such that they reach a detector with a time delay. The substance sample can be formed as a mixture of gases and/or liquids. The method comprises a first step in which a concentration of a first component of the substance sample is ascertained quantitatively. Here, the first component is the component of the substance sample that reaches the detector first after passing through the separating apparatus. Ascertaining quantitatively should be understood as measuring with the detector. The result of the quantitative detection of the concentration of the first component represents a first partial measured value which is forwarded, i.e., output, to an artificial intelligence for further use.

This is followed by a second step in which the artificial intelligence in each case ascertains the concentration of the second and third component. The artificial intelligence uses the first partial measured value to ascertain the concentration of the second and third component. To ascertain the concentrations of the second and third component in each case, the first partial measured value serves as an input value for the artificial intelligence, which uses it to calculate the concentrations of the second and third component. This calculation can be established as an experience-based estimate based on historical data relating to the concentrations of the first, second and third component.

The method also comprises a third step in which the concentration of the second component of the substance sample is ascertained quantitatively. Herein, the second component is the component of the substance sample that reaches the detector after the first component and is quantitatively detected by the detector. The result of this quantitative detection should be understood as the second partial measured value, which is forwarded, i.e., output, to the artificial intelligence for further use. The first and second partial measured value are then available to the artificial intelligence and are used together.

In a fourth step of the method, the concentration of the third component of the substance sample is ascertained via the artificial intelligence. With the first and second partial measured values, the artificial intelligence has a broader base of measured data so that fewer concentrations need to be ascertained for the artificial intelligence. The fourth step is performed using the first and second partial measured values. As a result, the concentration of the third component is possible with greater accuracy. In accordance with the invention, the first to fourth step of the method occurs within a first measurement cycle of the gas chromatograph in which the substance sample is analyzed. The first measurement cycle begins with the introduction of substance sample into the separating apparatus and ends when a new substance sample is injected into the separating apparatus.

As a result, the method in accordance with the invention is suitable for repeatedly specifying a concentration for the second and third component during the first measurement cycle; this is ascertained by the artificial intelligence. During the measurement cycle, the concentrations ascertained by the artificial intelligence become increasingly accurate. The invention is inter alia based on the surprising finding that an artificial intelligence enables missing partial measured values during the first measurement cycle to be temporarily replaced by calculated concentrations with sufficient accuracy. Hence, the composition of the substance sample can be specified each time a partial measured value is detected or on each artificial intelligence calculation cycle. This inter alia leads to the surprising effect that, for each measurement cycle, the more components to be detected that the substance sample includes, the more compositions are ascertained. Overall, the complexity of an analysis task to be resolved acts as an acceleration for the artificial intelligence used. This, for example, allows accelerated detection of an improper composition of the substance sample. Likewise, the claimed method can be used to implement automated manufacturing methods in which the composition of a process medium is critical and at the same time sensitive to interfering influences. Furthermore, the composition of the substance sample is ascertained without additional hardware and can also be easily implemented in existing gas chromatographs during the course of retrofitting, for example, the replacement of an evaluation unit.

In one embodiment of the method, the artificial intelligence is formed as a neural network, a statistics module or a combination thereof. A neural network should particularly be understood to be an algorithm that is suitable for ascertaining at least one output value from incomplete and/or ambiguous input values, which is to be regarded as the most likely correct result based on the input values. Neural networks can be configured largely independently for their intended task using a “training” dataset. Neural networks can likewise be further trained during operation using collected data. For example, in the claimed method, the neural network can already be configured for the method by a training dataset and can develop continuously in this time. This means the informative value of the artificial intelligence can easily be increased for specific applications. For each step in which concentrations of components of the substance sample are to be ascertained, the same neural network can be used in which nodes of the neural network are automatically adapted with each quantitatively ascertained partial measured value. This achieves an increased degree of homogeneity in the behavior of the artificial intelligence over an entire measurement cycle. Alternatively, a separate neural network can be used as an artificial intelligence for each of the steps outlined. This results in increased step-specific adaptation of the artificial intelligence for each corresponding step. Alternatively or additionally, in the claimed method, the artificial intelligence can also be established as fuzzy logic. The statistics module should, for example, be understood to be a computing unit for performing statistical evaluations, for example, via Bayesian statistics, least squares regression or similar numerical methods.

Furthermore, the artificial intelligence can be trained by a training dataset. The training dataset can include data from historical ascertainments of compositions of substance samples. For example, the data from historical ascertainments can comprise values for at least one of the partial measured values, in particular the first, second and/or third partial measured values. In particular, the data from the historical ascertainments of compositions can be ascertained on gas chromatographs of the same or similar construction. A gas chromatograph of a similar construction has the same technical properties as the gas chromatograph on which the claimed method is performed. A gas chromatograph of a similar construction is technically similar to the gas chromatograph upon which the disclosed method is performed to the extent that the respective partial measured values are transferable.

Moreover, the inventive method can also comprise a fifth step in which the concentration of the third component of the substance sample is ascertained quantitatively. For this purpose, like the first and second component, the third component is detected via the detector. Furthermore, in the fifth step, the concentration of the third component ascertained quantitatively in this way is output as a third partial measured value. In particular, the third partial measured value can be output to the artificial intelligence. The concentration of the third component ascertained by the artificial intelligence in the fourth step can thus be checked using the third partial measured value. For example, a corresponding marking on a graphical user interface can highlight to a user of the gas chromatograph that a composition based entirely on partial measured values is now displayed. Furthermore, after the fifth step, the end of the first measurement cycle can be recognized and a subsequent second measurement cycle initiated. This minimizes inactive phases in the disclosed method.

In addition, in the disclosed method, partial measured values and corresponding concentrations of corresponding components that are ascertained by the artificial intelligence can be made available to the artificial intelligence for machine learning. The partial measured values and the corresponding concentrations can be stored in relation to one another in a dataset that can serve as a training dataset for the artificial intelligence or supplement such a dataset. A relatively compact set of data that is particularly suitable for machine learning, and thus the independent development of the artificial intelligence, can be provided for each method run, i.e., each measurement cycle. Consequently, the disclosed method is suited for particularly targeted further development.

Furthermore, in the disclosed method, a sixth step can be performed in which a concentration of a residue, i.e., a residual component, of the substance sample is detected. Here, the residue can comprise one or more components and is not one of the components of the substance sample detected via the detector or the artificial intelligence. The concentration of the residue is obtained from a difference between the sum of concentrations ascertained by the detector or the artificial intelligence and a total concentration of the substance sample. In addition, the concentration of the residue, i.e., the residual component, ascertained in this way can be compared with an adjustable threshold value. If the concentration of the residue exceeds the adjustable threshold value, in particular exceeds it in terms of amount, then a warning can be issued. The threshold value can, for example, be specified by the user, a table or an algorithm. As a result, the disclosed method includes a tolerance against the residue that is not analyzed in more detail, which can be adapted to the present application. As a result, the disclosed method can also be used in applications with fault-prone operating conditions in which unexpected contamination of the substance samples can occur. In particular, the third component of the substance sample can be the residual component.

In a further embodiment of the method, the concentration of the second and/or third component of the substance sample ascertained by the artificial intelligence can be output with an error margin and/or confidence interval. Concentrations that are only ascertained by the artificial intelligence, but are not yet supported by partial measured values are inherently subject to uncertainty. Outputting the associated error margin or confidence interval enables a user and/or a control system to decide whether further decisions are to be made on the basis of the composition ascertained in this way or whether further partial measured values are to be awaited. As a result, the method in accordance with the disclosed embodiment can also be used with sufficient reliability in applications that are sensitive to interference. The time until an ascertained composition of the substance sample is sufficiently reliable or precise is shortened overall by the disclosed method.

Likewise, in the disclosed method, a difference can be ascertained between a concentration ascertained by the artificial intelligence and the corresponding partial measured value. If the difference exceeds an adjustable anomaly threshold value in terms of amount, then a warning can be issued. The warning can be issued to a user or to a control program. This, for example, enables an abrupt increase or decrease in the concentration of a component to be identified. This could be caused by a closed supply valve, the stoppage of an upstream process from which the substance sample is taken or by a defect on the detector and/or on the evaluation unit. The disclosed method can also be established to use the artificial intelligence or a separate method coupled to the artificial intelligence to recognize the course of such an anomaly. This can, for example, occur via an experience database. Furthermore, the user can, for example, minimize the issue of unnecessary warnings by setting the anomaly threshold appropriately. As a result, the disclosed method is also suitable for ensuring the reliable operation of an automation system in which the method is used for identifying defects at an early stage.

In addition, in the disclosed method, the second and/or fourth step can be performed taking account of a process parameter. The process parameter can, for example, be a temperature, a pressure, a pH value, an electrical quantity such as impedance, conductivity and/or an optical quantity, which are present in the process medium from which the substance sample is taken, or in a process by which the substance sample is produced. For example, in the case of a waste gas serving as a substance sample, the associated combustion temperature can be taken into account as a process parameter by the artificial intelligence, i.e., as an input variable, when ascertaining concentrations of components. For a large number of fuels, the combustion temperature determines the concentrations of carbon dioxide or nitrogen oxides produced. This enables the disclosed method to adapt dynamically to a given operating situation. Accordingly, the method in accordance with the disclosed embodiments is also suitable for regulating or controlling sensitive processes in which rapid reactions are required.

Moreover, in the disclosed method, during the first measurement cycle, an intermediate measured value for at least one component of the substance sample can be provided by an auxiliary analysis apparatus. An auxiliary analysis apparatus should, for example, be understood to be a continuous gas analyzer, a Raman spectrometer, a laser spectrometer, a non-dispersive infrared sensor (NDIR sensor), or a mass spectrometer. Compared to a gas chromatograph, such auxiliary analysis apparatuses offer reduced measuring accuracy. The auxiliary analysis apparatus can be used to provide a measured value between ascertaining a concentration of a component by the artificial intelligence and the quantitative detection, for example, via the detector; this should be regarded as an auxiliary measured value. This enables the concentration of a component ascertained by the artificial intelligence to be checked for plausibility during the method. Furthermore, auxiliary measured values can also be made available to an artificial intelligence for machine learning. In particular, the concentrations of all components of the substance sample that are ascertained in the disclosed method by the artificial intelligence or measured by the detector can be ascertained by the auxiliary analysis apparatus. This enables the disclosed method to be further supported and any defects on the gas chromatograph to be identified.

In one embodiment of the disclosed method, the auxiliary analysis apparatus has a measurement cycle duration that is shorter than the first measurement cycle. Thus, the auxiliary analysis apparatus can perform multiple measurements during a measurement cycle, i.e., two or more auxiliary measured values can be provided for each component. Then, the artificial intelligence does not ascertain the concentrations for components that have not yet been measured, but also when at least one new auxiliary measured value is available. As a result, more calculation runs can be performed with the artificial intelligence for each measurement cycle, which makes the ascertainment of the concentrations that have not yet been measured more precise.

The objects and advantages in accordance with the invention are also achieved by an evaluation unit that is configured to interact with an analysis apparatus that serves to ascertain a composition of a substance sample. For this purpose, in a mounted state, the evaluation unit is connected to at least one detector and is suitable for receiving measurement signals from the detector. In accordance with the invention, the evaluation unit is configured to perform at least one embodiment of the above-described embodiments of the method. For this purpose, the evaluation unit can, for example, includes a processor and memory and can be equipped with a computer program product that implements the corresponding method. The evaluation unit can furthermore be formed as a combination of a plurality of hardware platforms that are communicatively connected to one another and interact to perform the corresponding method, for example, in a computer cloud. The evaluation unit in accordance with the invention can also be retrofitted in the course of an upgrade of an existing system. As a result, the method in accordance with the disclosed embodiments of the invention can be transferred to existing systems in a simple manner.

The objects and advantages in accordance with the invention are similarly achieved by a gas chromatograph that is configured to ascertain the composition of a substance sample. For this purpose, the gas chromatograph comprises a separating apparatus, for example, a “separation column”, and a detector. The detector can, for example, be formed as a flame ionization detector, a thermal conductivity detector, a photoionization detector, a mass spectrometer or an ion mobility spectrometer. The detector is connected to an evaluation unit that is configure to receive and evaluate measurement signals from the detector. In accordance with the invention, the evaluation unit is configured in accordance with an embodiment of the above-described embodiments. The evaluation unit in accordance with the disclosed embodiments enables the above-described method to be implemented on the gas chromatograph in accordance with the invention. This increases the measuring speed, i.e., the frequency with which the compositions of the substance sample to be measured are output. At the same time, the increased measuring accuracy of a gas chromatograph is maintained. The gas chromatograph in accordance with the invention does not require any additional hardware components, so that the technical advantages outlined can be achieved economically.

The above-described objects and advantages in accordance with the invention are likewise achieved by an analysis system in accordance with the invention, which is configured to ascertain a composition of a substance sample. The analysis system comprises an auxiliary analysis apparatus, which is formed as a Raman spectrometer, a continuous gas analyzer, a laser spectrometer, a non-dispersive infrared sensor (NDIR sensor), or as a mass spectrometer. The auxiliary analysis apparatus is connected to an evaluation unit, which is suitable for receiving and evaluating measurement signals from the auxiliary analysis apparatus. The evaluation unit is used to store an executable artificial intelligence via which the composition of the substance sample is to be ascertained. In accordance with the invention, the artificial intelligence is trained by a method in accordance with the above-described embodiments. This is to be understood as meaning that the recognition behavior of an artificial intelligence is specified by a training dataset which is obtained by the above-described method in accordance with the disclosed embodiments. The artificial intelligence is in particular suitable for using measurement signals received from the auxiliary analysis apparatus as partial measured values in the sense of the method in accordance with the disclosed embodiments of the invention. The invention is inter alia based on the surprising discovery that such an artificial intelligence can be used to create a virtual gas chromatograph with the measuring accuracy of a real gas chromatograph. Therefore, in such cases, the gas chromatograph in accordance with the disclosed embodiments of the method is a virtual gas chromatograph. Here, however, the analysis system in accordance with the invention only requires one or more auxiliary analysis apparatuses, which as such have a lower measuring accuracy than a gas chromatograph. Thus, the analysis system can be formed as being free of a gas chromatograph, i.e., a real gas chromatograph. The technical advantages of a gas chromatograph can be achieved cost-effectively with the analysis system in accordance with the invention, which can be regarded as a virtual gas chromatograph, even with simpler hardware.

The objects and advantages in accordance with the invention are furthermore achieved by a computer program product in accordance with the invention, which is configured to ascertain the composition of a substance sample. The computer program product comprises an artificial intelligence, which can, for example, be structured as a neural network and a training dataset. The training dataset is suitable for specifying the behavior of the artificial intelligence when ascertaining the composition of the substance sample by machine learning (ML). The training dataset can be expanded during the operation of the computer program product by additional values, in particular partial measured values and corresponding ascertained concentrations of components of the substance sample. In accordance with the invention, the computer program product is configured to implement at least one embodiment of the above-described method. In particular, the computer program product is suitable for serving as an artificial intelligence in the sense of the method. Herein, the computer program product can be established as monolithic, i.e., as executable on a hardware platform. Alternatively, the computer program product can comprise a plurality of subprograms that interact communicatively in order to realize the desired functionality, for example, in a computer cloud. The computer program product can be fully or partially formed as software or hardwired, for example in a chip, microcontroller or FPGA. The computer program product in accordance with the invention can be provided in a simple manner for an existing evaluation unit, so that the method in accordance with disclosed embodiments of the invention can also be implemented on existing evaluation units.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below with reference to individual embodiments in figures. The figures should be understood to be complementary to one another to the extent that the same reference symbols have the same technical meaning in different figures. The features of the different embodiments can be combined with one another and with the features outlined above, in which:

FIG. 1 shows the structure of an embodiment of the gas chromatograph in accordance with the invention;

FIG. 2 shows a course of a first embodiment of the method in accordance with the invention;

FIG. 3 shows a course of a second embodiment of the method in accordance with the invention;

FIG. 4 shows an embodiment of the analysis system in accordance with the invention;

FIG. 5 is a flowchart of the method in accordance with the invention.

### DETAILED DESCRIPTION OF THE EXEMPLARY EMBODIMENTS

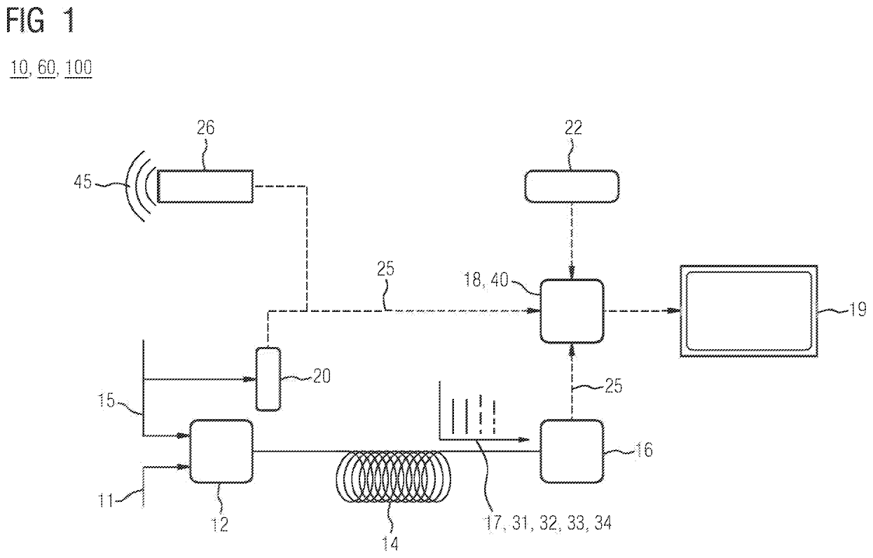

The structure of one embodiment of the disclosed gas chromatograph 10 is depicted schematically in FIG. 1. The gas chromatograph 10 comprises an injection apparatus 12, into which a carrier gas 11 can be introduced. The carrier gas 11 is in contact with a substance sample 15 in order to introduce it into a separating apparatus 14, which is formed as a separation column. The separating apparatus 14 divides the substance sample 15 into individual components 31, 32, 33, 34. The individual components 31, 32, 33, 34 reach a detector 16 one after the other and the detector is configured to quantitatively detect the individual components 31, 32, 33, 34. For this purpose, the detector 16 outputs measurement signals 25 to an evaluation unit 18 that has an artificial intelligence 40 stored in memory. The artificial intelligence 40 serves to evaluate the measurement signals 25 from the detector 16 in order to determine the composition 17 of the substance sample 15. For this purpose, the artificial intelligence 40 is established to implement at least one embodiment of the disclosed method 100.

The gas chromatograph 10 is equipped with an auxiliary analysis apparatus 20, which can be formed as a continuous gas analyzer or Raman spectrometer. The same substance sample 15 is fed/supplied to the auxiliary analysis apparatus 20 as is fed/supplied to the injection apparatus 12. The auxiliary analysis apparatus 20 is suitable for ascertaining the composition 17 of the substance sample 15, but with a lower precision than the detector 16. On the other hand, the auxiliary analysis apparatus 20 is suitable for ascertaining the composition 17 of the substance sample 15 in this way more quickly than the detector 16. Corresponding measurement signals 25 can be output by the auxiliary analysis apparatus 20 to the evaluation unit 18 to support the artificial intelligence 40. In addition, the evaluation unit 40 is coupled to a sensor 26 via which a process parameter 45 can be detected. The process parameter 45 influences the composition 17 of the substance sample 15. Measurement signals 25 reflecting the process parameter 45 are output from the sensor 26 to the evaluation unit 18 to support the artificial intelligence 40.

The artificial intelligence 40 can be coupled to a training dataset 22 that enables the artificial intelligence 40 to ascertain the composition 17 of the substance sample 15 from measurement signals 25 from the detector 16, the auxiliary analysis apparatus 20 and the sensor 26. For this purpose, the training dataset 22 contains data on historical ascertainments of compositions 17 of substance samples 15 on gas chromatographs 10 of the same or similar construction. The training dataset 22 can also be supplemented with measurement signals 25 and results of self-executed ascertainments of compositions 17 of substance samples 15. The ascertained compositions 17 are output on an output unit 19 structured as a screen. The artificial intelligence 40 and the training dataset 22 together form a computer program product 60 that enables the implementation of the claimed method 100.

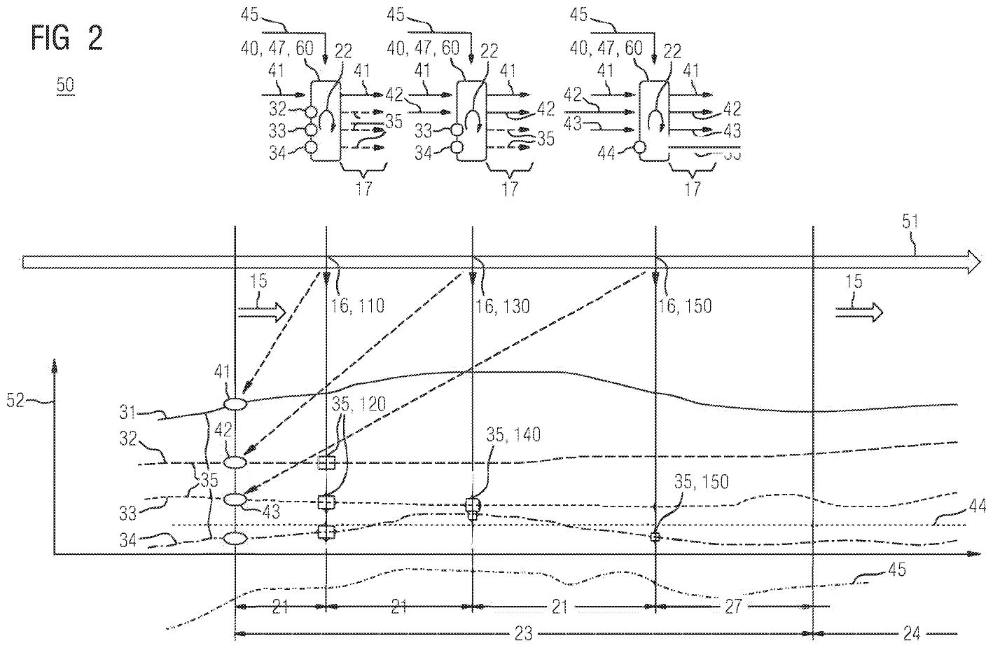

FIG. 2 depicts a course of a first embodiment of the inventive method 100 in a diagram 50 with a horizontal time axis 51. In the lower part, the diagram 50 has a vertical value axis 52 depicting the course of concentrations 35 and the course of a process parameter 45. The diagram 50 depicts a first measurement cycle 23 in which the composition 17 of a substance sample 15 is ascertained that includes a first component 31, a second component 32, a third component 33 and a residual component 34. The start of the first measurement cycle 23 is defined by the injection of the substance sample 15 into a separating apparatus 14, as shown in FIG. 1. After a retention time 21, which is characteristic of the first component 31 in combination with the separating apparatus 14, it reaches the detector 16 and is quantitatively detected in a first step 110. The result of this detection represents a first partial measured value 41 reflecting the concentration 35 of the first component 31 at the start of the first measurement cycle 23. In the first step 110, the first partial measured value 41 is also output to an artificial intelligence 40, which is formed as a neural network 47 and uses the first partial measured value 41 as input.

This is followed by a second step 120 in which the composition 17 of the substance sample 15 is ascertained by the artificial intelligence 40 based on the first partial measured value 41. As symbolized by the empty circles in FIG. 2, at the time of the first step 110, the artificial intelligence 40 is not provided with any partial measured values for the second component 32, the third component 33 or the residual component 34. The concentrations 35 of the second component 32, the third component 33 and the residual component 34 are ascertained in the second step 120 via the artificial intelligence 40 that is trained by a training dataset 22. During the ascertaining in the second step 120, the process parameter 45 which, as shown in FIG. 1, is ascertained by a sensor 26, is also taken into account. Thus, after completion of the second step 120, a result is provided for the composition 17 of the substance sample 15 that is based with the first partial measured value 41 on a real measurement with the detector 16 and three concentrations 35 resulting from the artificial intelligence 40. This composition 17 ascertained in the second step 120 can be output via an output unit 19.

After a further duration, which is characterized by a retention time 21 of the second component 32 in the separating apparatus 14, has elapsed, the second component 32 is quantitatively detected by the detector 16. The quantitative detection of the second component 32 occurs in a third step 130. The quantitative detection in the third step 130 provides a second partial measured value 42 reflecting the concentration 35 of the second component 32 at the start of the first measurement cycle 23. Here, the second partial measured value 42 is output to the artificial intelligence 40 that uses this as further input. This is followed by a fourth step 140 in which the artificial intelligence 40 is provided with the first and second partial measured value 41, 42, but not with any information about the concentrations 35 of the third component 33 or the residual component 34, as symbolized by the empty circles. In the fourth step 14, the artificial intelligence 40 ascertains the concentration 35 of the third component 33 and the residual component 34 based on the first and second partial measured value 41, 42. Here, the artificial intelligence 40 is based on its training dataset 22 and the process parameter 45. In the fourth step 140, at the start of the first measurement cycle 23, a composition 17 of the substance sample 15 is ascertained that is based on the first and second partial measured value 41, 42 and that is supplemented by concentrations 35 for the third component 33 and the residual component 34, which are ascertained by the artificial intelligence 35. Due to the fact that two partial measured values 41, 42 are already provided in the fourth step 140, the concentrations 35 of the third component 33 and the residual component 34 can be ascertained with increased accuracy, in particular in comparison to the second step 120. The composition 17 ascertained in the fourth step 140 can likewise be output via an output unit 19 of the gas chromatograph 10.

Similarly to the first and third steps 110, 130, the fourth step 140 is also followed by a fifth step 150 in which a concentration 35 of the third component 33 is ascertained via the detector 16. The result of the fifth step 150 is forwarded as a third partial measured value 43 to the artificial intelligence 40 which uses this as input. Taking into account the first, second and third partial measured values 41, 42, 43, the artificial intelligence 40 also ascertains a concentration 35 for the residual component 44 in the fifth step 150 taking into account the process parameter 45. From this, a composition 17 of the substance sample 15 is obtained, which comprises three partial measured values 41, 42, 43 and a concentration 35 for the residual component 34 ascertained by the artificial intelligence 40. The composition 17 obtained in this way can likewise be output via the output unit 19 of the gas chromatograph 10.

When ascertaining the concentration of the residual component 34, an adjustable threshold value 44 is taken into account during at least one of the steps 110, 120, 130, 140, 150. If the concentration 35 of the residual component 34 exceeds the adjustable threshold value 44, a warning is issued to a user, for example, via the output unit 19. The fifth step 150 is followed by an inactive phase 27 in which no further measurements via the detector 16 or ascertaining via the artificial intelligence 40 occur. The occurrence of the inactive phase 27 can be recognized by the fact that a result is provided for the composition 17 of the substance sample 15 that can no longer be further specified by additional measurements with the detector 16. During the inactive phase 27, the separating apparatus 14 can be rinsed, for example. Alternatively, the inactive phase 27 can be shortened by injecting a new substance sample 15. The injection of a new substance sample 15 initiates a second measurement cycle 24 in which the described steps 110, 120, 130, 140, 150 from the first measurement cycle 23 can be performed once again. In contrast to conventional solutions, in the first measurement cycle 23, three results are output for the composition 17 of the substance sample 15 instead of only one result. In an automation installation, for example, this allows accelerated response to an operating state that is not as intended. The inclusion of the process parameter 45 enables the artificial intelligence 40 to precisely predict the concentrations 35 expected for the first, second and third components 31, 32, 33 35 at the start of the second measurement cycle 24. This represents an automatic development of the training dataset 22. The method 100 shown in FIG. 2 is implemented via a computer program product 60 comprising the artificial intelligence 40 and the training dataset 22.

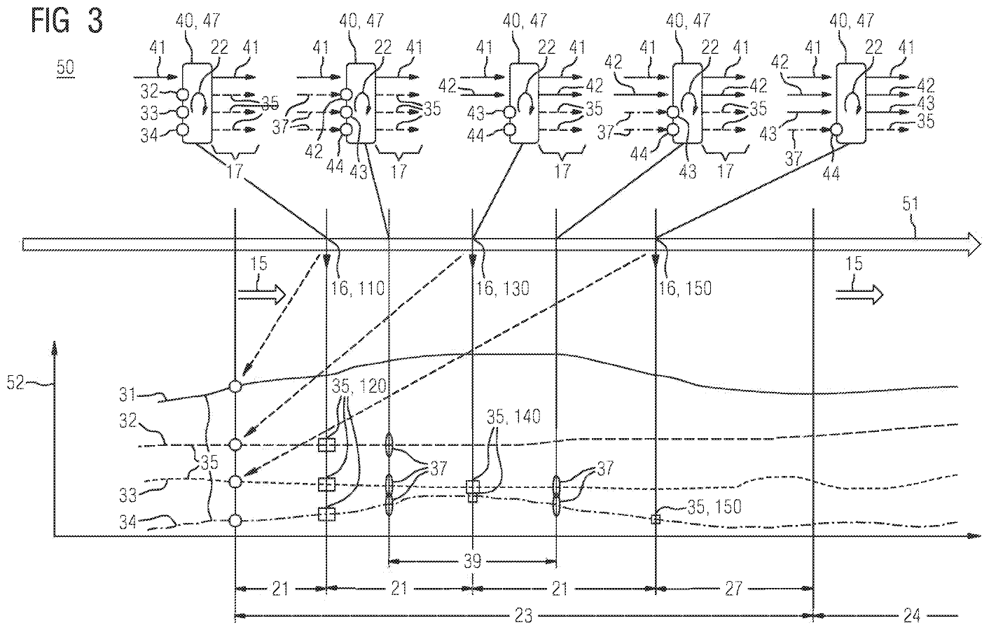

A second embodiment of the disclosed method 100 is depicted schematically in FIG. 3. The course of the second embodiment of the disclosed method 100 is depicted in a diagram 50 with a horizontal time axis 51. In the lower part, the diagram 50 has a vertical value axis 52 depicting the course of concentrations 35. The diagram 50 depicts a first measurement cycle 23 in which the composition 17 of a substance sample 15 is ascertained which includes a first component 31, a second component 32, a third component 33 and a residual component 34. The start of the first measurement cycle 23 is defined by the injection of the substance sample 15 into a separating apparatus 14, as shown in FIG. 1. After a retention time 21, which is characteristic of the first component 31 in combination with the separating apparatus 14, it reaches the detector 16 and is quantitatively detected in a first step 110. The result of this detection represents a first partial measured value 41 reflecting the concentration 35 of the first component 31 at the start of the first measurement cycle 23. In the first step 110, the first partial measured value 41 is also output to an artificial intelligence 40, which is embodied as a neural network 47 and uses the first partial measured value 41 as input.

This is followed by a second step 120 in which the composition 17 of the substance sample 15 is ascertained by the artificial intelligence 40 based on the first partial measured value 41. As symbolized in FIG. 2 by the empty circles, at the time of the first step 110, the artificial intelligence 40 is not provided with any partial measured values for the second component 32, the third component 33 or the residual component 34. The concentrations 35 of the second component 32, the third component 33 and the residual component 34 are ascertained in the second step 120 via the artificial intelligence 40 that is trained by a training dataset 22. Thus, after completion of the second step 120, a result is provided for the composition 17 of the substance sample 15 that, with the first partial measured value 41, is based on a real measurement with the detector 16 and three concentrations 35 resulting from the artificial intelligence 40. This composition 17 ascertained in the second step 120 can be output via an output unit 19.

Between the second step 120 and a third step 130 of the inventive method 100, the composition 17 of the substance sample 15 is ascertained by means of an auxiliary analysis apparatus 20, as shown in FIG. 1. In each case, the auxiliary analysis apparatus 20 generates an auxiliary measured value 37 for the second component 32, the third component 33 and the residual component 34. The auxiliary measured values 37 represent the concentrations 35 of the corresponding components 32, 33, 34, but have reduced measuring accuracy compared to partial measured values 41, 42, 43. Based on the first partial measured value 41 and the auxiliary measured values 37 for the second component 32, the third component 33 and the residual component 34, the artificial intelligence 40 ascertains a composition 17 of the substance sample 15. Similarly to the result from the second step 120, this result can also be output via the output unit 19.

After a further duration, which is characterized by a retention time 21 of the second component 32 in the separating apparatus 14, has elapsed, the second component 32 is quantitatively detected by the detector 16. The quantitative detection of the second component 32 occurs in a third step 130. The quantitative detection in the third step 130 provides a second partial measured value 42 reflecting the concentration 35 of the second component 32 at the start of the first measurement cycle 23. Here, the second partial measured value 42 is output to the artificial intelligence 40 that uses this as a further input. This is followed by a fourth step 140 in which the artificial intelligence 40 is provided with the first and second partial measured value 41, 42, but not with any information about the concentrations 35 of the third component 33 or the residual component 34, as symbolized by the empty circles. In the fourth step 14, the artificial intelligence 40 ascertains the concentration 35 of the third component 33 and the residual component 34 based on the first and second partial measured value 41, 42. Here, the artificial intelligence 40 is based on its training dataset 22. In the fourth step 140, at the start of the first measurement cycle 23, a composition 17 of the substance sample 15 is ascertained that is based on the first and second partial measured value 41, 42 and is supplemented by concentrations 35 for the third component 33 and the residual component 34 that are ascertained by the artificial intelligence 35. Due to the fact that two partial measured values 41, 42 are already provided in the fourth step 140, the concentrations 35 of the third component 33 and the residual component 34 can be ascertained with increased accuracy, in particular in comparison to the second step 120. The composition 17 ascertained in the fourth step 140 can likewise be output via an output unit 19 of the gas chromatograph 10. The results for the composition 17 that are obtained in the second step 120, in the fourth step 140 and in between based on the auxiliary measured values 37 can be compared with one another and thus can be mutually checked. Such a plausibility check can, for example, be performed by forming differences between the ascertained concentrations 35 for corresponding components 32, 33, 34 of the substance sample 15 and evaluating them in terms of amount. From this, a characteristic value, not shown in further detail, can be ascertained, which is comparable with an anomaly threshold value at least in terms of amount.

In a similar way, between the third step 130 and the fifth step 150, a composition 17 of the substance sample 15 is ascertained once again via the auxiliary analysis apparatus 20 and made available to the artificial intelligence 40 in the form of auxiliary measured values 37. Between the third and fifth step 130, 150, only auxiliary measured values 37 for the concentrations 35 of the third component 33 and the residual component 34 are ascertained or forwarded to the artificial intelligence 40. Based on the first and second partial measured values 41, 42 and the auxiliary measured values 3 for the third component 33 or the residual component 34, concentrations 35 for these are ascertained by the artificial intelligence 40. Together with the first and second partial measured value 41, 42, these concentrations 35 form an indication of the composition 17 of the substance sample 15. The composition 17 ascertained in this way can be output via the output unit 19.

Similarly to the first and third steps 110, 130, after the fourth step 140, a fifth step 150 is also performed in which a concentration 35 of the third component 33 is ascertained by means of the detector 16. The result of the fifth step 150 is forwarded to the artificial intelligence 40 as the third partial measured value 43 which uses this as input. Taking into account the first, second and third partial measured value 41, 42, 43, the artificial intelligence 40 also ascertains a concentration 35 for the residual component 44 in the fifth step 150 taking into account the process parameter 45. From this, a composition 17 of the substance sample 15 is obtained, which comprises three partial measured values 41, 42, 43 and a concentration 35 ascertained for the residual component 34 by the artificial intelligence 40. The composition 17 obtained in this way can likewise be output via the output unit 19 of the gas chromatograph 10.

As shown in FIG. 3, the auxiliary analysis apparatus 20 has a measurement cycle duration 39 that is shorter than the first measurement cycle 23. The auxiliary analysis apparatus 20 is suitable for outputting auxiliary measured values 37 to the artificial intelligence 40 several times per measurement cycle 23, 24. The auxiliary measured values 37 are each ascertained between the detection of two partial measured values 41, 42, 43. As a result, additional compositions 17 are ascertained in addition to the compositions 17 ascertained in the second, fourth and fifth step 120, 140, 150. Therefore, according to FIG. 3, five compositions 17 are ascertained per measurement cycle 23, 24. The auxiliary measured values 37 and the concentrations 35 ascertained on this basis can be stored and can be added to the training dataset 22 of the artificial intelligence 40. Such enrichment of the training dataset 22 leads to accelerated machine learning of the artificial intelligence.

The fifth step 150 is followed by an inactive phase 27 in which no further measurements are performed. In the inactive phase 27, the separating apparatus 14 can be rinsed, as shown in FIG. 1. Alternatively, the onset of the inactive phase 27 can be recognized by the artificial intelligence 40 and shortened accordingly. The inactive phase 27 and thus also the first measurement cycle 23 ends with the start of the second measurement cycle 24. The second measurement cycle 24 starts when a new substance sample 15 is injected. Steps 110, 120, 130, 140, 150 depicted with regard to the first measurement cycle 23 and the use of the auxiliary analysis apparatus 20 can be transferred analogously to the second measurement cycle 24.

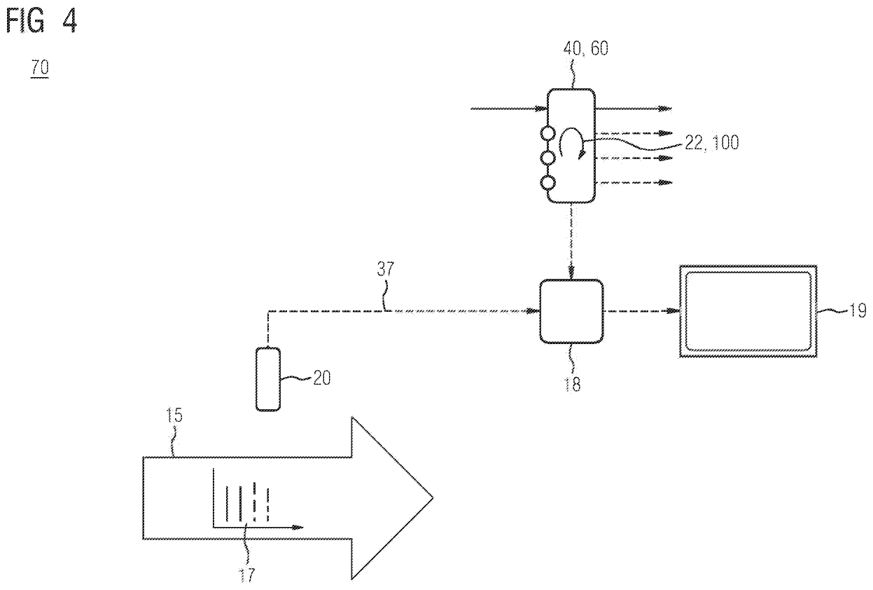

FIG. 4 shows an embodiment of the disclosed analysis system 70 that includes an auxiliary analysis apparatus 20 which is structured as a Raman spectrometer or a continuous gas analyzer. The auxiliary analysis apparatus 20 is connected to an evaluation unit 18. Furthermore, the auxiliary analysis apparatus 20 is configured to analyze the composition 17 of a substance sample 15 that is formed as a substance flow.

Corresponding measured data is transferred to the evaluation unit 18 as auxiliary measured values 37. The evaluation unit 18 is equipped with an artificial intelligence 40 for ascertaining the composition 17. The artificial intelligence 40 is trained using a training dataset 22, i.e., it is configured to ascertain the composition 17 of the substance sample 15. The training dataset 22 is at least partially generated from a method 100 in accordance with the above-described embodiments. Thus, the artificial intelligence 40 is at least partially trained by such a method 100. As a result, the artificial intelligence 40 is to ascertain the composition 17 of the substance sample 15 with increased precision, free of a detector 16 as in a gas chromatograph 10 according to FIG. 1. The analysis system 70 in FIG. 4 is to be understood as a virtual gas chromatograph, which, free of detectors 16, i.e., free of real gas chromatographs 10, offers similar or equivalent measuring accuracy. The analysis system 70 is particularly cost-efficient and suitable for providing the functionality of a real gas chromatograph 10 as in FIG. 1 with reduced hardware expenditure.

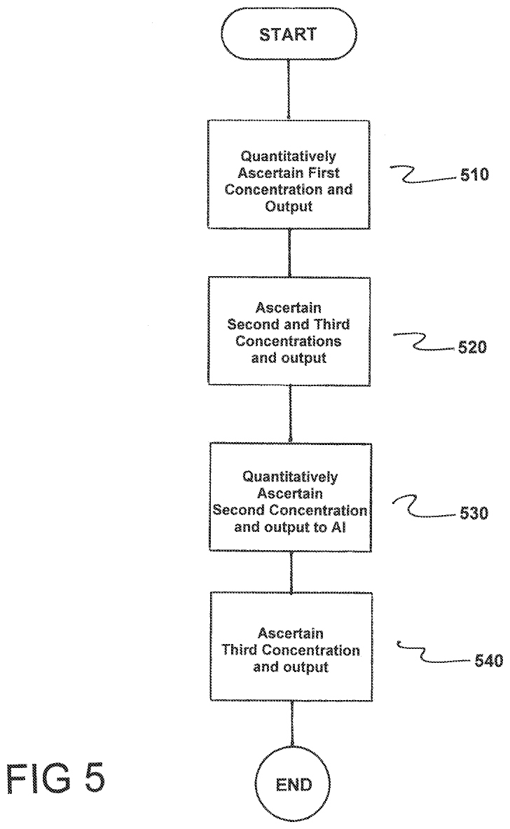

FIG. 5 is a flowchart of the method 100 for ascertaining the composition of a substance sample 15 having at least three components 31, 32, 33, 34 via a gas chromatograph 10. The method comprises a) quantitatively ascertaining a concentration 35 of a first component 31 of the substance sample (15) and outputting the concentration 35 to an artificial intelligence 40 as a first partial measured value 41, as indicated in step 510.

Next, b) the concentration 35 of a second and a third component 32, 33 of the substance sample 15 are ascertained via the artificial intelligence 40 utilizing the first partial measured value 41 and outputting the ascertained concentrations 35 is output, as indicated in step 520.

Next, c) the concentration 35 of the second component 32 of the substance sample 15 are quantitatively ascertained and the quantitatively ascertained concentration 35 is output to the artificial intelligence 40 as a second partial measured value 42, as indicated in step 430.

Next, d) the concentration 35 of the third component 33 of the substance sample 15 is ascertained via the artificial intelligence 40 utilizing the first and second partial measured values 41, 42 and the ascertained concentration 35 is output, as indicated in step 440.

In accordance with the method, steps 510 to 540 ((a) to d)) are performed within a first measurement cycle 23 of the gas chromatograph 10 in which the substance sample 15 is analyzed.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-17. (canceled)

18. A method for ascertaining a composition of a substance sample having at least three components via a gas chromatograph, the method comprising:
a) quantitatively ascertaining a concentration of a first component of the substance sample and outputting the concentration to an artificial intelligence as a first partial measured value;
b) ascertaining a concentration of a second and a third component of the substance sample via the artificial intelligence utilizing the first partial measured value and outputting the ascertained concentrations;
c) quantitatively ascertaining the concentration of the second component of the substance sample and outputting the quantitatively ascertained concentration to the artificial intelligence as a second partial measured value; and
d) ascertaining the concentration of the third component of the substance sample via the artificial intelligence utilizing the first and second partial measured values and outputting the ascertained concentration;
wherein steps a) to d) are performed within a first measurement cycle of the gas chromatograph in which the substance sample is analyzed.

19. The method for ascertaining the composition of the substance sample as claimed in claim 18, wherein the artificial intelligence comprises at least one of a neural network, fuzzy logic and a statistics module.

20. The method for ascertaining the composition of the substance sample as claimed in claim 18, wherein the artificial intelligence is trained by a training dataset.

21. The method for ascertaining the composition of the substance sample as claimed in claim 19, wherein the artificial intelligence is trained by a training dataset.

22. The method for ascertaining the composition of the substance sample as claimed in claim 20, wherein the training dataset comprises data on historical ascertainments of compositions of substance samples on gas chromatographs of the same or similar construction.

23. The method for ascertaining the composition of the substance sample as claimed in claim 18, wherein, during step e), the concentration of the third component of the substance sample is ascertained quantitatively and the concentration of the third component is output as a third partial measured value.

24. The method for ascertaining the composition of the substance sample as claimed in claim 18, wherein partial measured values and corresponding concentrations of components of the substance sample ascertained by the artificial intelligence are provided for machine learning of the artificial intelligence.

25. The method for ascertaining the composition of the substance sample as claimed in claim 18, wherein, during step f), a concentration of a residual component of the substance sample is detected and a warning is issued if the concentration of the residual component exceeds an adjustable threshold value.

26. The method for ascertaining the composition of the substance sample as claimed in claim 18, wherein the concentration of at least one of the second and third components of the substance sample ascertained by the artificial intelligence are output with at least one of an error margin and a confidence interval.

27. The method for ascertaining the composition of the substance sample as claimed in claim 18, wherein a difference is ascertained between a concentration of the at least three components ascertained by the artificial intelligence and the corresponding partial measured value and a warning is issued if the difference exceeds an adjustable anomaly threshold value in terms of amount.

28. The method for ascertaining the composition of the substance sample as claimed in claim 18, wherein at least one of step b) and d) is performed while taking into account a process parameter.

29. The method for ascertaining the composition of the substance sample as claimed in claim 28, wherein the process parameter comprises at least one of a temperature, a pressure, a pH value and an electrical quantity.

30. The method for ascertaining the composition of the substance sample as claimed in claim 18, wherein an auxiliary measured value of an auxiliary analysis apparatus is provided during the first measurement cycle for the concentration of at least one component of the substance sample.

31. The method for ascertaining the composition of the substance sample as claimed in claim 28, wherein the auxiliary analysis apparatus has a measurement cycle duration which is less than a measurement cycle duration of the first measurement cycle.

32. An evaluation unit for an analysis apparatus, said evaluation unit being configured to ascertain a composition of a substance sample and being connectable to at least one detector, the evaluation unit comprising:
a processor; and
memory;
wherein the evaluation unit is configured to:
a) quantitatively ascertain a concentration of a first component of the substance sample and output the concentration to an artificial intelligence as a first partial measured value;
b) ascertain a concentration of a second and a third component of the substance sample via the artificial intelligence utilizing the first partial measured value and output the ascertained concentrations;
c) quantitatively ascertain the concentration of the second component of the substance sample and output the quantitatively ascertained concentration to the artificial intelligence as a second partial measured value; and
d) ascertain the concentration of the third component of the substance sample via the artificial intelligence utilizing the first and second partial measured values and output the ascertained concentration;
wherein steps a) to d) are performed within a first measurement cycle of the gas chromatograph in which the substance sample is analyzed.

33. A gas chromatograph for ascertaining a composition of a substance sample, the gas chromatograph comprising:
at least one separating apparatus; and
one detector connected to the evaluation unit as claimed in claim 32.

34. An analysis system for ascertaining a composition of a substance sample, comprising:
an evaluation unit including a stored executable artificial intelligence; and
an auxiliary analysis apparatus formed as a Raman spectrometer or continuous gas analyzer and connected to the evaluation unit,
wherein the artificial intelligence is generated by:
a) quantitatively ascertaining a concentration of a first component of the substance sample and outputting the concentration to the artificial intelligence as a first partial measured value;
b) ascertaining a concentration of a second and a third component of the substance sample via the artificial intelligence utilizing the first partial measured value and outputting the ascertained concentrations;
c) quantitatively ascertaining the concentration of the second component of the substance sample and outputting the quantitatively ascertained concentration to the artificial intelligence as a second partial measured value; and
d) ascertaining the concentration of the third component of the substance sample via the artificial intelligence utilizing the first and second partial measured values and outputting the ascertained concentration;
wherein steps a) to d) are performed within a first measurement cycle of a gas chromatograph in which the substance sample is analyzed.

35. A computer program product for ascertaining a composition of a substance sample comprising an artificial intelligence and a variable training dataset, wherein the computer program product is configured to perform the method as claimed in claim 18.
